(19) United States
(12) Patent Application Publication
(10) Pub. No.: US 2014/0323617 A1
(43) Pub. Date: Oct. 30, 2014

(54) SUBSTRATE BINDING PROCESS

(71) Applicant: Global Telecom Organisation S.A., Luxembourg (LU)

(72) Inventors: Hendrik De Keukeleire, Luxembourg (LU); Rudy Galle, Roeselare (BE)

(73) Assignee: GLOBAL TELECOM ORGANISATION S.A., Luxembourg (LU)

(21) Appl. No.: 14/361,853

(22) PCT Filed: Nov. 30, 2012
(86) PCT No.: PCT/EP2012/074037

§ 371 Date: May 30, 2014

(30) Foreign Application Priority Data
Dec. 1, 2011 (NL) 1039207
May 21, 2012 (GB) 1208904.1

(51) Int. Cl. C08K 3/40; C08K 7/00; C08K 3/34; C08K 7/02; C08K 5/1545; C08K 5/053

(52) U.S. Cl. CPC C08K 3/40; C08K 5/1545; C08K 5/053; C08K 3/346; C08K 7/02; C08K 7/00
USPC 524/13; 524/430; 524/27; 524/388; 524/387; 524/447

(57) ABSTRACT

The invention relates to a process and composition for binding of a particulate or fibrous substrate, in particular natural particles or fibres such as for example wood particles and fibers, but also other natural fibers such as straw, flax, grass, straw, hemp, bagasse and bamboo. The current invention describes the composition of a cheap binder that can bind particles and fibers in a fast way, resulting in substrates that have the required mechanical properties. The binder has a good sustainability so that the end product also has an improved sustainability profile. Furthermore, the new binder composition will make the resulting substrates (composite materials) flame retardant.

### FIELD OF THE INVENTION

The invention relates to a process and composition for binding of a particulate or fibrous substrate, in particular natural particles or fibres such as for example wood particles and fibers, but also other natural fibers such as straw, flax, grass, hemp, bagasse, bamboo and agricultural waste. The current invention describes the composition of a cheap binder that can bind particles and fibers in a fast way, resulting in substrates that have the required mechanical properties. The binder has a good sustainability so that the end product also has an improved sustainability profile. The binder also enables the production of panels with reduced densities while keeping the mechanical properties at a good level. Furthermore, the new binder composition will make the resulting substrates (composite materials) flame retardant.

### BACKGROUND OF THE INVENTION

There is a need for a cheap binder system that can bind particles or fibers to each other and this in a more sustainable way than with current binder systems. Currently, mostly binder products based on formaldehyde resins are being used. These formaldehyde resins are condensation products mainly between formaldehyde and urea. However, this addition reaction can be reversible leading to the release of formaldehyde. Formaldehyde is known for its potential carcinogenic effects and therefore finding substitutes for this type of binders is highly desirable.

Formaldehyde resin binders are often used to bind natural particles or fibers. The best known example is the binding of wood fibers and particles leading to reconstituted wood panels. Such panels are well known under the names of e.g. medium dense fiber board, high density fiber board, oriented strand board, chipboard, particle board, hard board. These products are predominantly based on products with a high sustainability profile. However, the use of formaldehyde resins have a dramatic effect on its sustainability. Often melamine is added to the condensation reaction to make the addition reaction of the formaldehyde less reversible. As a result less formaldehyde is released. However, there is still some release of formaldehyde.

Furthermore, the use of formaldehyde resins works well for wood, but not for e.g. other fibers such as straw.

Isocyanates have being introduced as alternatives for the formaldehyde resins. These products are much more expensive and they need to be handled with great precautions because of the toxicity of the isocyanates. Therefore, a lot of investments are needed to be able to handle these isocyanate products in a safe way. Other companies have started with the commercialization of polyacrylate dispersions as binder materials. Preferably, a crosslinker needs to be added to the polyacrylate so that the binding properties are enhanced. However, these polyacrylates are not only quite expensive, but their chemical curing reaction is often slow. High curing temperatures or long curing times are needed to give the resultant substrate sufficient strength.

### SUMMARY OF THE INVENTION

In a first aspect, the present invention provides a curable composition comprising:
a particulate or fibrous substrate, in particular natural particles or fibres, and
a binder comprising a water glass binder and one or more thermoplastic materials;
   wherein at least one of the thermoplastic materials has ester groups, and
   wherein the weight ratio of the combined amount of water glass binder and thermoplastic materials to the amount of substrate is between 1:200 to 1:4.

In other words, the present invention provides a curable composition comprising;
a particulate or fibrous substrate, in particular natural particles or fibres;
a water glass binder; and
one or more thermoplastic materials;

characterized in that;
the at least one of the thermoplastic materials has ester groups, and
in that the weight ratio of the combined amount of water glass binder and the total amount of thermoplastic materials, to the amount of substrate is between 1:200 to 1:4.

In a preferred embodiment, at least one of the one or more thermoplastic materials is water borne.

In another preferred embodiment, the water glass binder has a ratio of SiO₂ to Na₂O ranging from about 1.5 to about 3.0; in particular from about 1.6 to about 2.8.

In another preferred embodiment, the thermoplastic material comprises a polymer selected from the group consisting of polyesters, polyacrylates polyvinylacetate or co-polymers of vinylacetate with ethylene or vinylchloride, and combinations thereof.

The current invention further provides a curable composition according to the present invention, wherein the composition further contains an organic polyalcohol. Preferably, the organic polyalcohol is selected from a carbohydrate, glycerine, trimethylolpropane or pentaerythritiol.

The curable composition according to the present invention may further contain a curing agent.

In a particular embodiment, the curing agent is selected from the list comprising; agents containing tertiary amino groups; low molecular weight organic or inorganic ester containing products; peroxides; peracids; percarbonates; and ammonium salts of organic or inorganic acids.

The curable composition according to the present invention may further contain an inorganic silicate containing pigment. Preferably, the inorganic pigment is a talcum, kaolin, mica, vermiculite or bentonite clay.

The present invention further provides a curable composition according to the present invention, wherein the water glass binder is a single water glass or a combination of different types of water glass having an average ratio of SiO₂ to Na₂O ranging from about 1.5 to about 3.0; in particular from about 1.6 to about 2.8.

In a preferred embodiment, the ratio between the water glass binder and the thermoplastic materials amounts to between about 1:2 to 1:0.05.

The present invention further provides a curable composition according to the present invention, wherein the binder is added to the fibers and the particles as a one component system.

The natural particles or fiber substrates, are preferably selected from the list comprising fresh or recycled wood, flax, straw, grass, hemp, bamboo, bagasse, agricultural waste or combination thereof. The particulate or fibrous substrate may also be a man-made (synthetic) substrate such as glass- or rock wool or a combination with natural fibers or particles.

The curable composition according to the present invention may further contain additives such as fillers, dyes, crosslinkers, pigments, UV-stabilizers, waxes.

In a further aspect, the present invention provides a composite material, obtainable by curing the composition according to this invention.

The present invention further provides a composite material according to the present invention, wherein the density of the composite material is between 400 and 850 kg\m³, more particularly between 480 and 700 kg\m³.

The present invention also provides the use of a binder comprising water glass and one or more thermoplastic materials, in the preparation of a curable composition according to the present invention.

The present invention further provides a method for the preparation of a curable composition according to the present invention, said method comprising
a) providing a particulate or fibrous substrate;
b) providing a binder consisting of water glass and one or more thermoplastic materials;
c) mixing the substrate with the binder to form said composition; and
wherein at least one of the thermoplastic materials has ester groups, and
wherein the weight ratio of the combined amount of water glass binder and thermoplastic materials to the amount of substrate is between 1:200 to 1:4.

In a particular embodiment, the present invention provides a method according to this invention, wherein the binder is provided as a one-component system.

In yet another embodiment, the present invention provides a method for the preparation of a composite material according to this invention, said method comprising
a) obtaining a curable composition according to this invention ; and
b) curing said composition under high temperature and pressure.

In said embodiment, preferably step step b) is performed at a temperature above the melting point or the glass transition temperature of the thermoplastic material. Furthermore, the pressure in step b) is preferably at least 2 bar. In addition, the temperature in step b) is preferably at least 100° C.

### DETAILED DESCRIPTION OF THE INVENTION

The present invention is based on the finding that the presence of an ester containing thermoplastic material as solidifying agent in a glass water binder composition for binding of a particulate or fibrous substrate, results in a composite material with previously unknown characteristics. As will be evident from the examples hereinafter, using a curable composition according to the present invention, the resulting material has a very homogenous structure, a high mechanical strength, a low density, an improved sustainability profile, an improved water resistance, an excellent dimensional stability, and very good cold tack of the treated fibers and particles, so that its processing is facilitated. The good properties are achieved by using a limited amount of binder, which is not only interesting from an economically point of view but it also makes sure that the resulting material (such as panels) is not too stiff or too brittle.

It is accordingly a first aspect of the present invention to provide a curable composition comprising:
a particulate or fibrous substrate, in particular natural particles or fibers, and
a binder comprising a water glass binder and one or more thermoplastic materials;
wherein at least one of the thermoplastic materials has ester groups, and
wherein the weight ratio of the combined amount of water glass binder and thermoplastic materials to the amount of substrate is between 1:200 to 1:4.

Whenever, in the present invention, reference is made to an amount, ratio or % of a substance (such as water glass binder, thermoplastic material, or substrate), it is meant to represent the dry matter weight, dry matter ratio or weight % of said substance, unless indicated otherwise.

The thermoplastic polymer can be present as a solution, a dispersion or an emulsion in water. The thermoplastic material can have a Tg or melting point in a wide range. Preferably, the Tg or Tm ranges between −60° C. and 250° C., more preferably between −40° C. and 160° C.

Examples of suitable thermoplastic materials are polyesters, polyamides, polyolefins such as polyethylene and polypropylene, polyvinylacetates, polyvinylchloride, polyacrylates.

According to this invention at least one of the thermoplastic materials contains ester functionalities, such as a polyester, an alkyd resin, a polyacrylate, a polyvinylacetate or co-polymers of vinylacetate and ethylene or vinylchloride. Thus in another aspect the binder composition comprises a polymer selected from the group consisting of polyesters, polyamides, polyolefins, polyvinyls, polyvinylacetate, polyacrylates, polyurethanes, and combinations/copolymers thereof. More in particular one of the thermoplastic material comprises an ester-containing polymer, such as a polyester, a polyacrylate, an alkyd resin a polyvinylacetate or co-polymers of vinylacetate with ethylene or vinylchloride.

The curable composition according to the present invention may contain other materials such as curing agents, compatibilizers, additives, fillers, pigments, opacifiers, UV-stabilizers, crosslinkers and catalysts. Thus in another embodiment of the present invention, the thermoplastic material or the water borne binder further contains one or more other materials such as curing agents, compatibilizers, additives, fillers, pigments, opacifiers, UV-stabilizers, cross-linkers and catalysts.

Particularly interesting other materials are curing agents; in particular agents that enhance the hydrolysis of the one or more ester groups of the thermoplastic material. Typical curing agents may be selected from the list comprising agents containing tertiary amino groups, peroxides, peracids, and percarbonates. Besides, the curing agents may consist of low molecular weight organic or inorganic ester containing products. In particular, said low molecular weight inorganic ester containing products are selected from the list comprising esters of a phosphate, carbonate or borate. Typical examples of organic esters are citrate esters such as for instance trimethyl or triethyl citrate, phthalate esters such as for instance dimethyl or diethyl phthalate, adipate esters such as for instance dimethyl or diethyl adipate, tartrate esters such as for instance dimethyl or diethyl tartrate.

Other interesting curing additives are latent acids such ammonium salts of acids, especially when the amine of the ammonium salt is volatile during the curing process. Typical examples of such curing agents are ammonium salts of carboxylic acids, nitrates, phosphates or sulfates.

Other interesting curing agents are products that improve the compatibility between the water borne binder, more specifically between water glass and the thermoplastic material. In order to enhance the curing reaction the water borne binder and the thermoplastic material should be able to come into contact with each other. Especially, when the water borne binder is hydrophilic and the thermoplastic material is hydrophobic a compatibilizer will have a positive effect on the curing reaction. Such compatibilizers are for instance products with an amphiphylic character, such as co-polymers of ethylene and propylene oxides, polyethylene oxides attached to an alkyl chain, carbohydrates with alkyl chains, fatty acid salts, sulphonated hydrocarbons such as for instance lignosulphonates, silicones attached to hydrophilic moieties.

In case the thermoplastic material is an emulsion or a dispersion in water, the thermoplastic material will already be surrounded by an agent to keep the thermoplastic material in the water phase. This agent can be chosen in such way that it not only keeps the thermoplastic in the water phase but that it also enhances the compatibility with the water borne binder. In case the thermoplastic material is a polyvinylacetate, an excellent dispersing agent is polyvinylalcohol as the polyvinyl alcohol also enhances the compatibility of the polyvinylacetate with the water glass.

Particularly interesting additives are polyalcohol containing products. When added to the silicate binder these polyalcohol containing products interact with the silicate leading to a product with an increased cold tack.

Cold tack is a required property during the processing of the fibers and particles, after they are treated with the binder and before they are hot pressed to panels. The binder treated fibers and particles are first cold pressed to a certain thickness and then brought on a conveyer belt. Without cold tack the cold pressed mat of fibers and particles would disintegrate and the fibers would fall between the conveyer belts during their transfer from one belt to the other.

Typical examples for the polyalcohol containing products are carbohydrates such as glucose, sucrose, fructose, dextrose, flour or starch, or low molecular weight polyalcohols such as glycerine, trimethylolpropane or pentaerythritol. The ratio between the silicate binder and the polyalcohol containing product is usually between 100:1 to 3:1, more preferably between 50:1 and 5:1, calculated on the solid materials. The polyalcohol containing products may be added as 100% solids, but also as a solution or dispersion in water.

Other interesting agents that enhance the interaction between the water glass and the ester containing thermoplastic polymers are silicate containing pigments. Examples of such pigments are clays or talcums, more specific pigments such as talcum, kaolin, mica, vermiculite and bentonite clays. The ratio between the silicate binder and the silicate containing pigment is usually between 100:1 to 2:1, more preferably between 50:1 and 3:1, calculated on the solid materials. The silicate containing pigments are preferably added in their solid form.

The water glass and the thermoplastic material can be mixed together before they are added to the fibers or the particles. In case more than one thermoplastic polymer is used, one of the thermoplastic materials can be mixed with the water glass or with the other thermoplastic materials. It is also possible to add the water glass and the thermoplastic material separately. In a preferred form the water glass binder is added first to the fibers or the particles, subsequently followed by the addition of the thermoplastic binder. The water glass binder will as a liquid be well distributed over the fiber or particles. Due to the presence of the water borne binder the thermoplastic binder will as well be better distributed over the fibers or particles.

Irrespective of the aforementioned ratio, a proper distribution of the thermoplastic material in the water glass binder is clearly enhanced when present as a water borne dispersion or emulsion

In case the thermoplastic material is an aqueous dispersion, the kind of stabilization of the dispersion plays an important role. Often polyvinylalcohol or partially hydrolyzed polyvinylacetate is used as a stabilizing agent, in a so-called colloid protection. However, this type of stabilizers reacts fast with the water glass binder leading to a destabilization of the colloid. In that case surfactants can be added to improve the mixing between the water glass and the thermoplastic material. Typical examples of such surfactants are co-polymers of ethylene and propylene oxides, polyethylene oxides attached to an alkyl chain, carbohydrates with alkyl chains, fatty acid salts, sulphonated hydrocarbons such as for instance lignosulphonates, silicones attached to hydrophilic moieties. The thermoplastic materials may also be stabilized by surfactants such as for instance the sodium salt of dodecenyl benzene sulfonic acid or by alkyl polyethylene oxides. In that case the mixing of the aqueous thermoplastic material with the glass binder will be facilitated and the result will also be more homogeneous.

In case of a solid material, a thermoplastic material with a fine particle size will be preferred as the thermoplastic material can just be mixed with water to form a dispersion. Upon stirring the thermoplastic material will be kept homogeneously distributed in the water phase.

Evidently from the foregoing, and given the presence of a water glass binder, depending on the ratio of glass binder to thermoplastic material, the consistency of binder according to the present invention will change when adding a solid thermoplastic material, from a more liquid (higher amount of water borne binder) to a more solid state (higher amount of thermoplastic particles). Within the context of the present invention, the ratio between the water glass and the thermoplastic material typically amounts to between about 1:3 and 50:1; in particular to between about 1:2 and 40:1.

Water glass is derived from sand and sodium hydroxide and as such does not contain products derived from fossil fuel. The type of water glass is described by its ratio SiO₂ to Na₂O. A higher ratio results in a product with lower water sensitivity. Principally, all types of water glass can be used in this application, ranging from a ratio of 1 to 3.5, but preference is given to a ratio of 1.5 to 3.0, and even more preferably between 1.6 and 2.8 Often the combination of water glasses with a different ratio can be beneficial. A water glass with a low ratio, for instance between 1.5 and 2.5, leads to a good wetting of the substrate and to improved cold tack, while a water glass with a higher ratio, for instance between 2.5 and 3.5 leads to a better cohesion of the particulates and the fibers, and to a better water resistance of the cured material.

As already explained hereinbefore, the binder of the present invention is of particular interest to bind particulate or fibrous substrate. Examples of the fibers or particles that can be bound are fresh or recycled wood, flax, grass, straw, hemp, bamboo, bagasse and agricultural waste. Preferably, these products have a natural origin. Principally, all kinds of natural products are useful as substrates, provided they are cut into particles or fibers. Agricultural waste streams that are not suitable for human consumption are of particular interest to be used as substrates. Rest products from for instance maize, wheat and rice production are very suitable as substrate material. It is also possible to use a mix of different substrates. It is also quite possible to use this binder concept for man-made fibers such as glass- or rock wool.

Thus, in another embodiment, the present invention provides a composition comprising a binder as defined herein and particles or fibrous substrate, in particular natural particles or fiber substrates such as for example ground wood, flax, bamboo, hemp, straw, waste streams from sawing mills, rest material from sugar cane or corn, or grass that has been cut in the desired fiber length. In a preferred embodiment the natural particles or fiber substrates are selected from the group consisting of fresh or recycled wood, flax, grass, straw, maize, hemp, bamboo, bagasse and agricultural waste.

In the solidification of the particulate or fibrous substrate using the binder according to the present invention, it is important that the binder and the substrate are good admixed with one another and that there is an evenly distribution of either component in the compositions thus obtained. Especially, when the amount of binder is below 10% of the total mass a very well mixing is crucial. Within the context of the present invention the weight ratio between the binder and the substrate typically amounts between 1:200 to 1:4, more particularly between 1:35 to 1:5, calculated on the solid materials. In other words, the weight ratio of the combined amount of water glass binder and thermoplastic materials, i.e. the sum of the amount of water glass binder to the amount of substrate is between 1:200 to 1:4, more particularly between 1:35 to 1:5.

In DE 4432019, DE 4413964, and EPO457516 the combined use of water glass and an aqueous polyvinylacetate as binder for a fibrous and particulate matter has been described, however use is made of a large amount of binder compared to the substrate material. A large amount of binder is favorable to get good binding strength between the fibres and particles. However, from an economical point of view it makes the process unattractive, and more importantly, the flexibility of the resultant panels becomes limited. In case of wood panels a good flexibility is required and furthermore the panels should allow screws to be fixed into the panels. A too brittle panel will lead to cracks when screws are fixed. Furthermore, the products made according to DE 4432019, DE 4413964, and EPO457516 will have a high density, as due to the high binder content the porosity of the substrate will be limited.

The curable composition according to this invention allows the use of a limited amount of binder. Furthermore, despite the low amount of a binder, a good cold tack and good mechanical properties can be obtained. This is further achieved by using a water glass with a SiO₂ to Na₂O ratio between 1.5 to 3.0, and even more preferably a ratio of 1.6 to 2.8. Also the use of the polyalcohol functional products and the silicate containing pigments has a positive effect on the cold tack and the mechanical properties.

As will be evident from the examples hereinafter, any one of the aforementioned compositions may further contain, additives such as fillers, dyes, crosslinkers, pigments, UV-stabilizers, waxes.

In another aspect the present invention provides composite materials made using the binder as described herein, i.e. using any one of the aforementioned compositions. In the manufacture of said composite materials, the aforementioned compositions comprising the natural fibers and particulates, and the binder are brought in a recipient and cured under high temperature and pressure. The curing temperature will be above the melting point or glass transition temperature of the thermoplastic material, alternatively even above 100° C. to remove the present water. A pressure of at least 2 bar is used during the curing process.

When the binders are a combination of a water glass and an ester containing thermoplastic material, some hydrolysis of the ester containing thermoplastic material will take place during the curing reaction, thereby leading to the formation of the sodium salt of the carboxylic acid. As a result the ratio SiO₂ to Na₂O of the water glass will increase. Therefore the water resistance of the cured material will become higher.

The water resistance of the substrate can be further increased by adding hydrophobizing agents such as e.g. oil or waxes.

In a further aspect of this invention the density of the composite materials (such as wood panels) will be between 400 and 850 kg\m³, more preferably between 480 and 700 kg\m³, even more preferably between 500 and 650 kg\m³. A reduced density of a wood panel is from an economical and ecological point of view a substantial improvement, however, usually the mechanical properties also deteriorate quite rapidly upon reducing the density.

This invention will be better understood by reference to the Experimental Details that follow, but those skilled in the art will readily appreciate that these are only illustrative of the invention as described more fully in the claims that follow thereafter. Particular embodiments and examples are not in any way intended to limit the scope of the invention as claimed. Additionally, throughout this application, various publications are cited. The disclosure of these publications is hereby incorporated by reference into this application to describe more fully the state of the art to which this invention pertains.

### EXAMPLES

### Example 1

500 g of fresh wood and 450 of recycled wood particles are well blended with a mixture of 120 g of water glass Si 2.95 from Silmaco (Belgium) and a 1 g 50% H₂O₂ solution in water. The water glass has a SiO₂ to Na₂O ratio of 2.95 and a dry matter content of 40%. Thereafter 50 g of Vinamul 8481(ex Celanese, Germany), which is a 54% dispersion of polyvinylacetate in water, is added to the wood particles and the mixing is proceeded for a further minute. The content of the mixture is brought into a mould with a surface of 30 cm by 30 cm and a height of 25 cm. The mixture is pressed at room temperature until the height of the content is 7 cm. The pressed material is now removed from the mould and brought between heated plates of 170° C. that are pressed together with a pressure of 100 tons. The thickness of the wood mixture is brought to a thickness of 15 mm and the pressure and the temperature of the plates at 170° C. is maintained during 5 minutes. Thereafter the pressure is released and the pressed wood is removed from the heated plates. After cooling down the mechanical properties of the wood panel are measured.

Density: 630 kg\m3

Tensile strength: 0.8 N\mm²

Bent strength: 12 N\mm²

Surface strength: 2.1 N\mm²

### Example 2

To 1000 g of dried wood fibers, of which the recycled content is 50%, and having an average fiber length of 2 mm, is added a mixture of 160 g of the water glass PQ 2.0 (from PQ Corporation),16 g of a solid kaolin clay and 16 g of a 50% solution of glucose in water. The water glass has a SiO₂ to Na₂O ratio of 2.0 and a dry matter content of 51%. This mixture was well stirred during 15 minutes before the addition to the wood fibres. Subsequently, 40g of a 61% polyvinylacetate dispersion (Vinnamul 9300 from Celanese) is added to the already treated wood fibres. The content of the mixture is brought into a mould with a surface of 30 cm by 30 cm and a height of 25 cm. The mixture is pressed at room temperature until the height of the content is 7 cm. The pressed material is now removed from the mould and brought between heated plates of 190° C. that are pressed together with a pressure of 100 tons. The thickness of the wood mixture is brought to a thickness of 15 mm and the pressure and the temperature of the plates at 190° C. is maintained during 3 minutes. Thereafter the pressure is released and the pressed wood is removed from the heated plates. After cooling down the mechanical properties of the wood panel are measured.

Density: 620 kg\m³

Tensile strength: 0.9 N\mm²

Bent strength: 28 N\mm²

Surface strength: 2.6 N\mm²

### Example 3

To 960 g of fresh wood fibers with an average fiber length of 2 mm, is added a mixture of 130 g of the water glass PQ 2.0 (from PQ Corporation), 8 g of a solid kaolin clay and 10 g of solid flour. This mixture was well stirred during 15 minutes before the addition to the wood fibres. The water glass has a SiO₂ to Na₂O ratio of 2.0 and a dry matter content of 51%. Subsequently, 40 g of a 54% polyvinylacetate dispersion (Vinnamul 8481 from Celanese) is added. The content of the mixture is brought into a mould with a surface of 30 cm by 30 cm and a height of 25 cm. The mixture is pressed at room temperature until the height of the content is 7 cm. The pressed material is now removed from the mould and brought between heated plates of 190° C. that are pressed together with a pressure of 100 tons. The thickness of the wood mixture is brought to a thickness of 17 mm and the pressure and the temperature of the plates at 190° C. is maintained during 3 minutes. Thereafter the pressure is released and the pressed wood is removed from the heated plates. After cooling down the mechanical properties of the wood panel are measured.

Density: 550 kg\m³

Tensile strength: 0.7 N\mm²

Bent strength: 24 N\mm²

Surface strength: 2.0 N\mm²

### Example 4

To a mixture of 130 g of the water glass PQ 2.0 (from PQ Corporation), 8 g of a solid kaolin clay and 10 g of solid flour is added 2g of a 20% solution of potassium oleate in water. The water glass has a SiO₂ to Na₂O ratio of 2.0 and a dry matter content of 51%. Subsequently, 40 g of a 54% polyvinylacetate dispersion (Vinnamul 8481 from Celanese) is added. This mixture was well stirred during 1 minute and then added as a one component binder to a mixture of 450 g of fresh and 500 g of recycled wood fibres. The content of the mixture is brought into a mould with a surface of 30 cm by 30 cm and a height of 25 cm. The mixture is pressed at room temperature until the height of the content is 7 cm. The pressed material is now removed from the mould and brought between heated plates of 190° C. that are pressed together with a pressure of 100 tons. The thickness of the wood mixture is brought to a thickness of 15 mm and the pressure and the temperature of the plates at 190° C. is maintained during 3 minutes. Thereafter the pressure is released and the pressed wood is removed from the heated plates. After cooling down the mechanical properties of the wood panel are measured.

Density: 630 kg\m³

Tensile strength: 0.85 N\mm²

Bent strength: 27 N\mm²

Surface strength: 2.6 N\mm²

All the mechanical strength values of the two panels from the examples are higher than a panel with a similar density and made with an equal amount of binder based on formaldehyde resins. Furthermore, the panels made in these examples will not burn when brought in a flame of 700° C. for 10 minutes.

1-25. (canceled)

26. A curable composition comprising:
a particulate or fibrous substrate; and
a binder comprising a water glass binder and one or more thermoplastic materials, wherein at least one of the one or more thermoplastic materials has ester groups, and wherein the weight ratio of the combined amount of the water glass binder and the one or more thermoplastic materials to the amount of the substrate is between 1:200 to 1:4.

27. The curable composition according to claim 26, wherein at least one of the one or more thermoplastic materials is water borne.

28. The curable composition according to claim 26, wherein the water glass binder has a ratio of SiO₂ to Na₂O ranging from about 1.5 to about 3.0.

29. The curable composition according to claim 26, wherein the one or more thermoplastic materials comprises a polymer selected from the group consisting of polyesters, polyacrylates, polyvinylacetate, co-polymers of vinylacetate with ethylene or vinylchloride, and combinations thereof.

30. The curable composition according to claim 26, wherein the composition further comprises an organic polyalcohol.

31. The curable composition according to claim 26, wherein the composition further comprises a curing agent.

32. The curable composition according to claim 31, wherein the curing agent is selected from the group consisting of agents containing tertiary amino groups, low molecular weight organic or inorganic ester containing products, peroxides, peracids, percarbonates, and ammonium salts of organic or inorganic acids.

33. The curable composition according to claim 30, wherein the organic polyalcohol is selected from the group consisting of a carbohydrate, glycerine, trimethylolpropane, and pentaerythritiol.

34. The curable composition according to claim 26, further comprising an inorganic silicate containing pigment.

35. The curable composition according to claim 34, wherein the inorganic silicate containing pigment is a talcum, kaolin, mica, vermiculite, or bentonite clay.

36. The curable composition according to claim 26, wherein the water glass binder is a single water glass or a combination of different types of water glass having an average ratio of SiO₂ to Na₂O ranging from about 1.5 to about 3.0.

37. The curable composition according to claim 26, wherein the ratio between the water glass binder and the one or more thermoplastic materials amounts to between about 1:2 to 1:0.05.

38. The curable composition according to claim 26, wherein the binder is added to the particulate or fibrous substrate as a one component system.

39. The curable composition according to claim 26, wherein the particulate or fibrous substrate is a natural particulate or fibrous substrate selected from the group consisting of fresh or recycled wood, flax, straw, grass, hemp, bamboo, bagasse, agricultural waste, and combinations thereof.

40. The curable composition according to claim 26, wherein the particulate or fibrous substrate is a man-made substrate selected from the group consisting of glass-wool, rock wool, and combinations thereof with natural fibers or particles.

41. The curable composition according to claim 26, further comprising additives.

42. A composite material obtained by curing the composition according to claim 26.

43. The composite material according to claim 42, wherein the density of the composite material is between 400 and 850 kg\m³.

44. A method for the preparation of a curable composition according to claim 26, said method comprising:
a) providing a particulate or fibrous substrate;
b) providing a binder consisting of water glass binder and one or more thermoplastic materials; and
c) mixing the substrate with the binder to form said composition, wherein at least one of the one or more thermoplastic materials has ester groups, and wherein the weight ratio of the combined amount of the water glass binder and the one or more thermoplastic materials to the amount of the substrate is between 1:200 to 1:4.

45. The method of claim 44, wherein the binder is provided as a one-component system.

46. A method for the preparation of a composite material, said method comprising:
a) obtaining a curable composition according to claim 26; and
b) curing said composition under high temperature and pressure.

47. The method according to claim 46, wherein step b) is performed at a temperature above the melting point or the glass transition temperature of the one or more thermoplastic materials.

48. The method of claim 46, wherein the pressure in step b) is at least 2 bar.

49. The method of claim 46, wherein the temperature in step b) is at least 100° C.
